(19) United States
(12) Patent Application Publication
(10) Pub. No.: US 2026/0027918 A1
(43) Pub. Date: Jan. 29, 2026

(54) DUAL AIR INTAKE SYSTEM FOR A VEHICLE

(71) Applicant: Daimler Truck North America LLC, Portland, OR (US)

(72) Inventors: Ali HADDADI, Tigard, OR (US); Nagasrinu PURAM, Bangalore (IN); Matthew MINDOLOVICH, Portland, OR (US); Ataman KAYIM, Portland, OR (US); Nishit SHARMA, Kota (IN); Jackson SLOCUM, Portland, OR (US)

(21) Appl. No.: 19/281,236

(22) Filed: Jul. 25, 2025

Related U.S. Application Data
(60) Provisional application No. 63/676,033, filed on Jul. 26, 2024.

(51) Int. Cl. B60L 50/72; H01M 8/04082; H01M 8/04089

(52) U.S. Cl. CPC B60L 50/72; H01M 8/04089; H01M 8/04201; B60L 2200/36

(57) ABSTRACT

A dual air intake system for supplying air to one or more fuel cells of a vehicle. The dual air intake system comprises a pair of air intakes comprising a respective pair of dividers, a pair of outlet channels coupled to the respective pair of air intakes, a pair of air filters coupled to the respective pair of outlet channels, and a manifold coupled to the pair of air filters. The air intakes are coupled to a cab of the vehicle facing outwards relative to a travel direction of the vehicle and further arranged at a sustainable height from front wheels of the vehicle for receiving the air and removing water/moisture from the received air. Due to such an arrangement of the air intakes, amount of cleaner air is uniformly supplied to the fuel cell(s) even during negative pressure effects on any of the air intakes.

### CROSS REFERENCE TO RELATED APPLICATIONS

This application claims priority to U.S. Application No. 63/676,033, filed on Jul. 26, 2024. The entire contents of this application are hereby incorporated by reference in their entireties.

### TECHNICAL FIELD

The present disclosure relates to an air intake system for supplying air to one or more fuel cells of a vehicle.

### BACKGROUND

With recent advances in fuel cell developments, vehicles and/or power trains use fuel cells for power generation. The fuel cells use hydrogen gas and oxygen from ambient air as reactants for generation of electric power supplied to electric motors of the vehicles. An air intake system of a vehicle can include an air intake and an air filter. The air intake allows the air to be drawn from the surrounding of the vehicle and guides the drawn air into the air filter. The air filter filters the air drawn by the air intake and supplies the filtered air to a motive source of the vehicle.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The present disclosure relates generally to a dual air intake system for supplying air to one or more fuel cells of a vehicle. More particularly, the present disclosure provides a system and method for improving the quality and reliability of air supplied to fuel cell stacks, thereby enhancing fuel cell efficiency and performance.

According to an example aspect, a dual air intake system includes a pair of air intakes, each of the pair of air intakes forming a passageway that includes a divider, and a pair of outlet channels, each of the pair of outlet channels coupled to a respective one of the pair of air intakes. Further, the dual air intake system includes a pair of air filters, each of the pair of air filters coupled to a respective one of the pair of outlet channels. Additionally, the dual air intake system includes a manifold coupled to an outlet of each of the pair of air filters, wherein the manifold has at least two outlets each configured to be coupled to at least one respective fuel cell.

In another example aspect, a vehicle includes a pair of air intakes, each of the pair of air intakes forming a passageway that includes a divider, and a pair of outlet channels, each of the pair of outlet channels coupled to a respective one of the pair of air intakes. The vehicle further includes a pair of air filters, each of the pair of air filters coupled to a respective one of the pair of outlet channels. Additionally, the vehicle includes a manifold coupled to an outlet of each of the pair of air filters, wherein the manifold has at least two outlets each configured to be coupled to at least one respective fuel cell.

In yet another aspect, a system for a vehicle includes two or more fuel cells, two or more air intakes, and a single manifold configured to receive air from each of the two or more air intakes and supply the air in substantially equal portion to each of the two or more fuel cells.

Additional aspects of the present disclosure are described in the following Detailed Description.

### BRIEF DESCRIPTION OF THE DRAWINGS

The examples of the present disclosure are described herein with reference to the accompanying figures. It should be noted that the description and figures relate to exemplary implementations and should not be construed as a limitation to the present disclosure. It is also to be understood that various arrangements may be devised that, although not explicitly described or shown herein, embody the principles of the present disclosure. Moreover, all statements herein reciting principles, aspects, and examples of the present disclosure, as well as specific examples, are intended to encompass equivalents thereof.

FIG. 1 is a rear perspective view of a vehicle, according to an example of the present disclosure.

FIG. 2A is a front perspective view of a dual air intake system of the vehicle, according to an example of the present disclosure.

FIG. 2B is a rear perspective view of the dual air intake system, according to an example of the present disclosure.

FIG. 3A is a front perspective view of the dual air intake system, according to an example of the present disclosure.

FIG. 3B is a top perspective view of the dual air intake system, according to an example of the present disclosure.

FIG. 4 is a rear left side perspective view of the dual air intake system, according to an example of the present disclosure.

FIG. 5 is a side perspective view of an air intake of the dual air intake system, according to an example of the present disclosure.

FIG. 6 is a cross-sectional view of the air intake, according to an example of the present disclosure.

FIG. 7 is a block diagram of a system for the vehicle, according to an example of the present disclosure.

### DETAILED DESCRIPTION

In the following description, certain specific details are set forth in order to provide a thorough understanding of various disclosed examples. However, one skilled in the relevant art will recognize that examples may be practiced without one or more of these specific details, or with other methods, components, materials, and the like. In other instances, well-known structures associated with a dual air intake system have not been shown or described in detail to avoid unnecessarily obscuring descriptions of the examples.

The present disclosure relates to a dual air intake system for a vehicle. The dual air intake system is provided for improving quality of air supply to one or more fuel cells of the vehicle and ventilating both sides of the vehicle. With improved quality of air supply, the efficiency and performance of the one or more fuel cells may be enhanced.

According to at least one aspect of the present disclosure, the dual air intake system comprises a pair of air intakes, a pair of outlet channels coupled to the respective pair of air intakes, a pair of air filters coupled to the respective pair of outlet channels, and a manifold coupled to an outlet of each of the pair of the air filters. The manifold has at least two outlets configured to be coupled to a respective fuel cell.

In certain aspects, adapting the pair of air intakes (rather than adapting a single air intake) in the dual air intake system may reduce the impact caused on the one or more fuel cells due to a negative pressure built on the vehicle. For example, when the vehicle is proceeding through other traffic on a road, the negative pressure may build on the vehicle and disrupt supply of the air to the one or more fuel cells. With the provision of the pair of air intakes in the present technology, the amount of air supply to each fuel cell may be uniformly distributed while compensating the negative pressure built on the vehicle. Further, if one air intake encounters any issue or stops operating, the other air intake may still facilitate the air supply for the one or more fuel cells while ensuring that the dual air intake system remains operational and uninterrupted. Thus, the pair of air intakes may offer a level of redundancy in the dual air intake system.

In certain aspects, the air intakes are arranged behind a cab of the vehicle and face outward to a normal travel direction of the vehicle. Thereby, introduction of debris into the air intakes may be reduced, which may subsequently reduce clogging of the air intakes.

In certain aspects, the dual air intake system may reduce impact of water/moisture on the air filters and the one or more fuel cells. For example, functional operations of the air filters and the one or more fuel cells may tend to be reduced, if the air filters and the one or more fuel cells are supplied with air having water/moisture. Therefore, the air intakes are arranged at a substantial height from front wheels of the cab (e.g., not too low and/or not too high from the front wheels), so that water/moisture entering the air intakes may be reduced.

In certain aspects, each air intake forms a passageway that includes a divider. The divider separates the water/moisture from the air before supplying the air to the air filters through the outlet channels. Thus, the water/moisture may be separated before reaching into the air filters, which may further enhance efficiency and performance of the air filters.

In certain aspects, each of the air intakes includes an air intake end having a flexible gasket affixed thereto. The flexible gasket compensates for a relative motion between the cab and the one or more fuel cells, which may be caused due to a motion of the vehicle.

In certain aspects, the dual air intake system further comprises a pair of flexible couplings integrated through the respective pair of air intakes and the pair of outlet channels, a pair of air intake isolators and an additional pair of air intake isolators for use in coupling the air intakes to the cab of the vehicle, and a pair of outlet channel isolators for use in coupling the outlet channels to a chassis of the vehicle. The flexible couplings, the air intake isolators, and the outlet channel isolators are adapted for dampening vibrations in the dual air intake system and compensating the relative motion between the cab, an extender portion of the cab, and the one or more fuel cells. Dampening of the vibrations and compensation of the relative motion in the dual air intake system further ensures consistent performance and integrity of the dual air intake system in supplying the air to the one or more fuel cells.

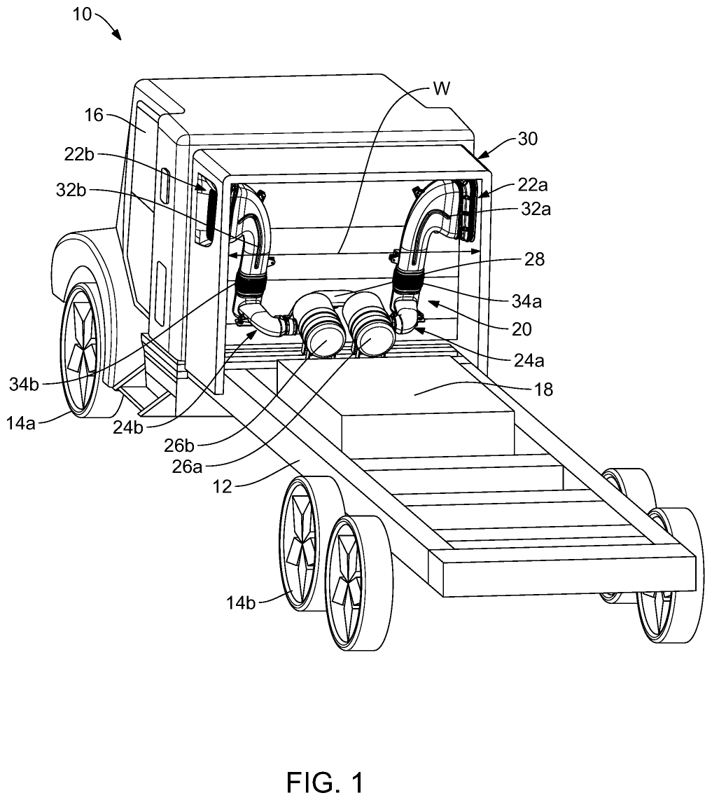

FIG. 1 is a rear perspective view of a vehicle 10, according to an example of the present disclosure. In some examples, the vehicle 10 is a heavy vehicle, which may be categorized from class 1 through class 8 based on weight of the vehicle. Class 1 includes vehicles that weigh 6000 lbs or less. Examples of class 1 vehicles include but may not be limited to minivan, cargo van, sports utility vehicle (SUV), and pickup truck. Class 2 includes vehicles that weigh between 6001 lbs to 10000 lbs. Examples of class 2 vehicles include but may not be limited to minivan, cargo van, full-size pickup vehicle, and step van. Class 3 includes vehicles that weigh between 10001 lbs to 14000 lbs, and examples include but may not be limited to walk-in vehicle, box truck, city delivery vehicle, and heavy-duty pickup vehicle. Class 4 includes vehicles that weigh between 14001 to 16000 lbs such as but may not be limited to large walk-in truck, box truck, and city delivery truck. Class 5 includes vehicles that weigh between 16001 lbs to 19500 lbs such as but may not be limited to bucket truck, large walk-in vehicle, city delivery bus, and the like. Class 6 includes vehicles that weigh between 19501 to 26000 lbs such as but may not be limited to beverage truck, school bus, single-axle, and rack truck. Class 7 includes vehicles that weigh between 26001 to 33000 lbs such as but may not be limited to refuse, furniture carrying truck/bus, city transit bus, and truck tractor. Lastly, class 8 includes vehicles that weigh 33001 lbs and more such as but may not be limited to dump truck, sleeper, cement truck, truck tractor, and the like.

The vehicle 10 in the form of the heavy vehicle, e.g., a truck, is illustrated in FIG. 1. Although the vehicle 10 is depicted in form of the heavy vehicle, the present disclosure is not limited to the heavy vehicle but may be used for other types of vehicles (i.e., other than the vehicles categorized under class 1 through class 8).

The vehicle 10 comprises a chassis 12 to which front wheels 14a (only a single front wheel 14a is shown) and back wheels (e.g., rear wheels) 14b are attached. The vehicle 10 further comprises a cab 16, which may be arranged above the front wheel 14a and mounted on the chassis 12. The cab 16 (also be referred to as cabin, driver's cab, and/or the like) may be equipped with a seat, a steering wheel, a dashboard, and other controls for operating the vehicle 10.

The vehicle 10 further comprises a fuel cell stack 18 for powering one or more electric motors (not shown), which are used for creating a propulsion force for the vehicle 10. In some examples, the fuel cell stack 18 may be arranged behind the cab 16 and mounted on the chassis 12, as illustrated in FIG. 1. In some examples, the fuel cell stack 18 may be arranged below the cab 16 and mounted on the chassis 12 (not shown). The fuel cell stack 18 may be mounted on the chassis 12 using couplers such as bolts, suspension hangers, and/or the like.

The fuel cell stack 18 comprises one or more fuel cells (not shown). As an example, the fuel cell stack 18 may comprise two fuel cells. While the figures and accompanying description pertain generally to a vehicle with two fuel cells, it is to be understood that any number of fuel cells (e.g., 1, 2, 3, 4, or more than 4) can be used in conjunction with the teachings herein.

The vehicle 10 further comprises a dual air intake system 20 for supplying air to each fuel cell of the fuel cell stack 18. The dual air intake system 20 comprises a pair of air intakes 22a-22b, a pair of outlet channels 24a-24b, a pair of air filters 26a-26b, and a manifold 28.

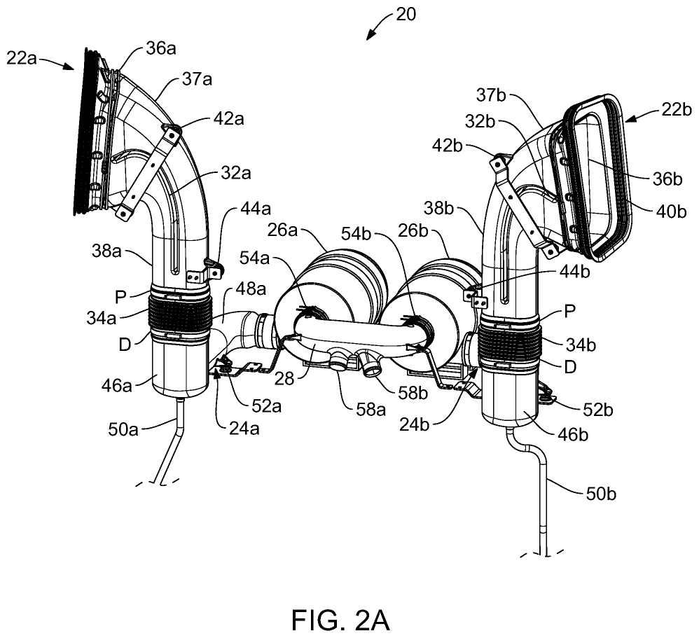

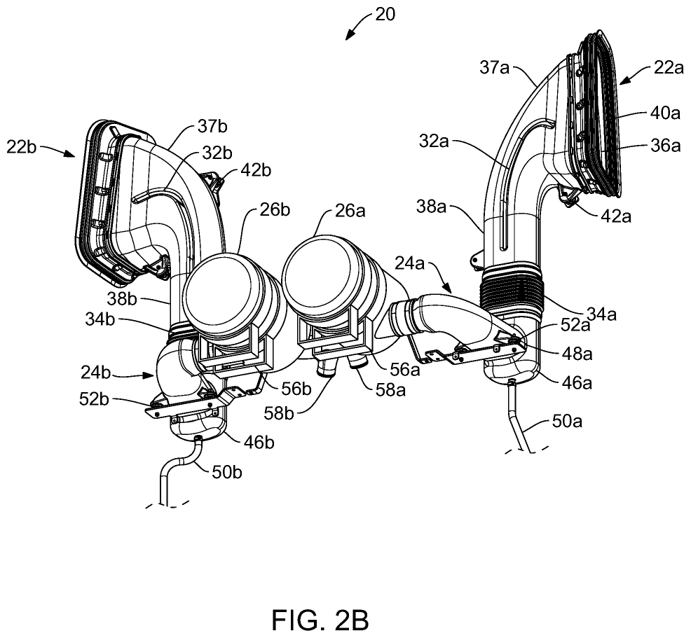

The air intakes 22a-22b (also be referred to as upper snorkels) may be attached to the cab 16 of the vehicle 10. For example, the air intakes 22a-22b may be attached to an extender portion 30 (also referred to as a side extender) of the cab 16. The attachment of the air intakes 22a-22b to the extender portion 30 of the cab 16 is described in detail in conjunction with FIGS. 2A and 2B.

Further, the air intakes 22a-22b may be arranged at a substantial height from the front wheels 14a of the vehicle 10 and positioned outward relative to a normal travel direction of the vehicle 10. Said another way, a plane corresponding to an opening of the air intakes may be substantially parallel to a normal travel direction of vehicle 10. In embodiments, the air intakes 22a-22b may be positioned substantially proximal to a top side of extender portion 30. As a result, entry of debris and water/moisture into the air intakes 22a-22b along with the air may be reduced. Furthermore, a first air intake 22a may be faced (e.g., substantially opposite-facing) and spaced a distance away from a second air intake 22b. In at least one example, the distance between the first air intake 22a and the second air intake 22b may be substantially equal to a horizontal width (W) of the vehicle 10, as illustrated in FIG. 1.

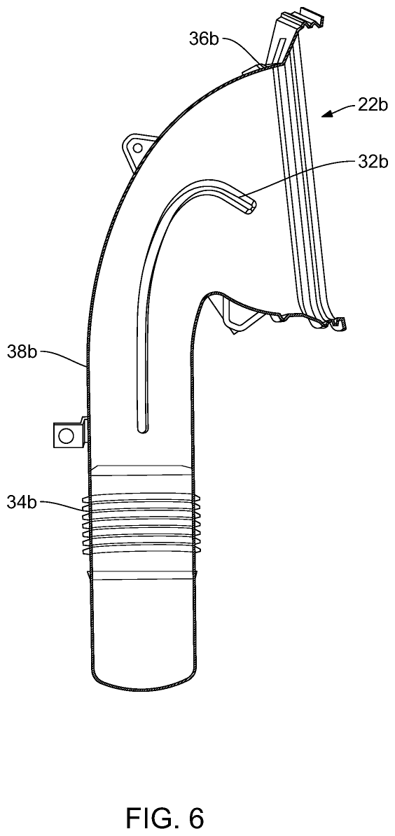

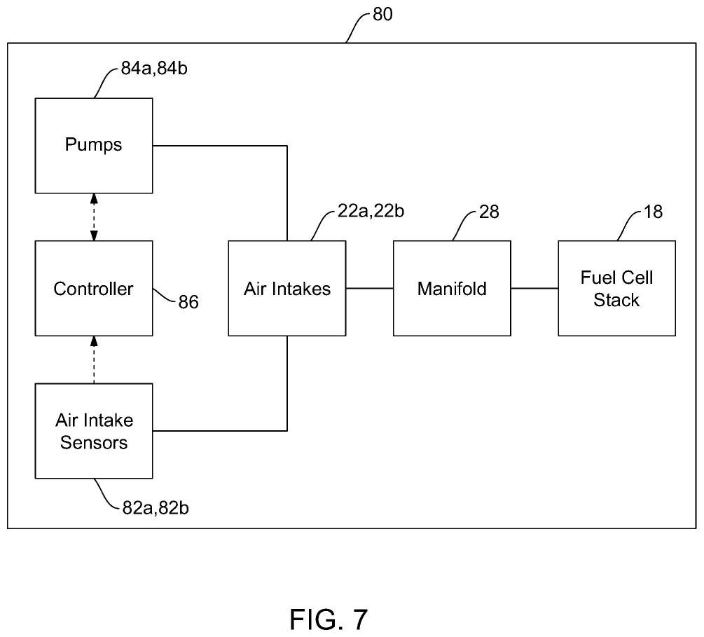

When the vehicle 10 is operational, each of the air intakes 22a-22b allows the air from the surroundings of the vehicle 10 to be drawn and/or pulled therethrough. In some examples, the dual air intake system 20 may include a backup arrangement to draw the air into the air intakes 22a-22b, when flow of the air entering the air intakes 22a-22b is low. The backup arrangement may include one or more air flow enhancement devices for drawing the air into the respective air intakes 22a-22b (described in detail in conjunction with FIG. 7). Once the air is drawn into the air intakes 22a-22b, water/moisture from the air is separated using respective dividers 32a-32b. The dividers 32a-32b function to enhance the separation of water or moisture from the incoming air stream by providing an increased surface area and directing separated water to a fluid collection portion 46a-46b. The dividers 32a-32b may include one or more water-separating surfaces, which can be planar, curved, or otherwise shaped to optimize water removal (described in further detail in conjunction with FIG. 6).

After reduction (e.g., removal) of the water/moisture from the air, the outlet channels 24a-24b (also referred to as lower snorkels) coupled to the respective air intakes 22a-22b and to the chassis 12 (described in detail in conjunction with FIGS. 2A-2B) guide the moisture-reduced air to the respective air filters 26a-26b. The separated/accumulated water is further drained out (refer to e.g., FIGS. 2A-2B). Thus, the water/moisture is separated before reaching the air filters 26a-26b, thereby enhancing efficiency and performance of the air filters 26a-26b. Accordingly, the dual air intake system 20 directs cleaned air to the air filters 26a-26b, minimizing water ingress into the air filters 26a-26b and reducing ram air effects.

In some examples, the dual air intake system 20 may include plenums (not shown). The plenums may be connected to the air intakes 22a-22b, respectively. The plenums may be configured to receive the air flowing through the respective air intakes 22a-22b and guide the air to the respective air filters 26a-26b. For example, when the vehicle 10 travels forwards, an amount of the air may flow through the plenums of the respective air intakes 22a-22b and to the respective air filters 26a-26b.

In some examples, each of the plenums may be integrated with a downturned pipe. The downturned pipe of a plenum may form a portion of an air path. Such a formed portion may force the air to flow downwards in the vertical direction of the vehicle 10 before flowing back upwards through the respective plenum. Thus, the downturned pipe integrated into the plenum may increase water/moisture separation from the air and direct the air with reduced moisture to the respective air filter 26a-26b.

Further, the air filters 26a-26b may be coupled to the respective outlet channels 24a-24b and to the chassis 12. The air filters 26a-26b may be operated to further filter the air received from the respective outlet channels 24a-24b and to provide the filtered air to the manifold 28. The manifold 28 may be configured so as to supply a uniform amount of filtered air to each fuel cell of the fuel cell stack 18. In other words, any differential air flow (e.g., differential amount) may be compensated via the manifold 28 such that an amount of air entering each of the fuel cells is substantially equal. Differential air flow may be seen, e.g., under conditions where one air filter is degraded (e.g., clogged or otherwise) to some extent greater than another air filter. If not compensated for, differential air intake into each fuel cell may result in undesired differential operational aspects of the fuel cell. The manifold 28 is described in further detail in conjunction with FIGS. 2A and 2B.

In some examples, the dual air intake system 20 further comprises a pair of flexible couplings 34a-34b (also referred to as bellows) which may be integrated through the respective pair of air intakes 22a-22b, and the pair of outlet channels 24a-24b. The flexible couplings 34a-34b are described in detail in conjunction with FIGS. 2A and 2B.

Various examples illustrating the components of the dual air intake system 20 are described in conjunction with figures in the later parts of the description.

FIGS. 2A and 2B are front and rear perspective views, respectively, of the dual air intake system 20, according to an example of the present disclosure. The dual air intake system 20 is adapted to supply the air to the fuel cell stack 18 comprising one or more fuel cells (e.g., two fuel cells). With reference to FIGS. 2A and 2B, the air intakes 22a-22b, the outlet channels 24a-24b, the air filters 26a-26b, and the manifold 28 of the dual air intake system 20 are described in detail.

The air intakes 22a-22b may allow the air to be received laterally from the surroundings of the vehicle 10 and may guide the air downwardly to the respective outlet channels 24a-24b while separating water/moisture from the air. Each air intake 22a-22b comprises an intake end 36a-36b, an intake portion 37a-37b, and a downwardly extending portion 38a-38b.

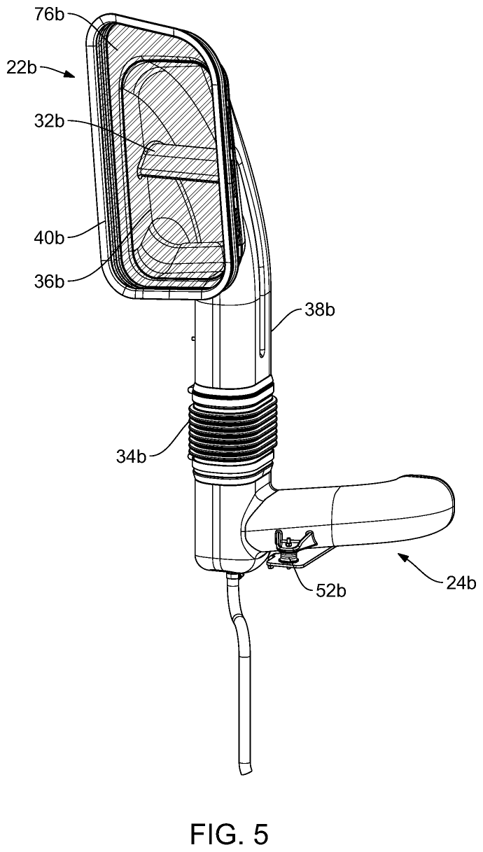

The intake ends 36a-36b of the respective air intakes 22a-22b may allow for the air to be received inside the respective intake portions 37a-37b. In some examples, the air may be received based on an air pressure differential built from the motion/movement and surroundings of the vehicle 10. In such a scenario, the air flow into the air intakes 22a-22b may not be sufficient. Therefore, the one or more air flow enhancement devices of the backup arrangement may be used to draw the air into the respective one or more air intakes 22a-22b. In an example, each of the one or more air flow enhancement devices may include a pump, an electric turbocharger, a fan, a blower, an air intake actuator, and/or any other type of device configured to controllably supply a flow of air. Within the context of this disclosure, the intake end 36a of the first air intake 22a faces away from the intake end 36b of the second air intake 22b. Thereby, the intake ends 36a-36b of the air intakes 22a-22b may be arranged at two opposite sides of the cab 16 of the vehicle 10. Further, the intake end 36a of the first air intake 22a is spaced at a distance from the intake end 36b of the second air intake 22b. In at least one example, the distance may be substantially a horizontal width (W) of the vehicle 10 (as illustrated in FIG. 1). In some examples, each intake end 36a-36b may have a respective flexible gasket 40a-40b affixed thereto. The flexible gasket 40a-40b is a deformable sealing element, potentially made from materials including but not limited to rubber or elastomeric material (e.g., 3D-printed rubber), designed to maintain an airtight seal between the air intake 37a-37b and the vehicle cab or extender portion. The flexible gasket 40a-40b may include features such as bellows or convolutions to accommodate movement and vibration, and may be attached via protrusions, glue, or pressure fit among other attachment mechanisms. One of the intake ends, e.g., the intake end 36b with the flexible gasket 40b is described in detail in conjunction with FIG. 5.

Each downwardly extending portion 38a-38b of the air intakes 22a-22b may extend from the respective intake end 36a-36b to the respective outlet channel 24a-24b through the respective intake portion 37a-37b. The air received inside the intake portions 37a-37b is guided to the respective outlet channels 24a-24b through the respective downwardly extending portions 38a-38b. A downwardly extending portion 38b is described in detail in conjunction with FIG. 5.

In some examples, the dual air intake system 20 comprises a pair of air intake isolators 42a-42b. In examples, the air intake isolators 42a-42b are frame-like structures arranged for coupling the air intakes 22a-22b to the cab 16 (e.g., to the extender portion 30 of the cab 16) of the vehicle 10 (as illustrated in FIG. 1). Each air intake isolator 42a-42b may be coupled to the intake portion 37a-37b of the respective air intake 22a-22b and may be operable to be coupled to the cab 16 of the vehicle 10.

In some examples, the dual air intake system 20 comprises an additional pair of air intake isolators 44a-44b along with the air intake isolators 42a-42b. For example, each additional air intake isolator 44a-44b may be coupled to one of the downwardly extending portions 38a-38b of the respective air intake 22a-22b and may be operable to be coupled to the cab 16 (e.g., to the extender portion 30 of the cab 16) of the vehicle 10.

In some examples, the air intake isolators 42a-42b and the additional air intake isolators 44a-44b may be coupled to the intake portions 37a-37b and the downwardly extending portions 38a-38b, respectively, of the respective air intakes 22a-22b and to the cab 16 using suitable bracket and fastener. The fastener referred to herein may be a securing element, which secures the respective air intake isolator 42a-42b or the additional air intake isolator 44a-44b to the respective intake portions 37a-37b or downwardly extending portion 38a-38b and to the cab 16. In some examples, the fastener may be a screw and bolt, a hook and barb, and/or the like.

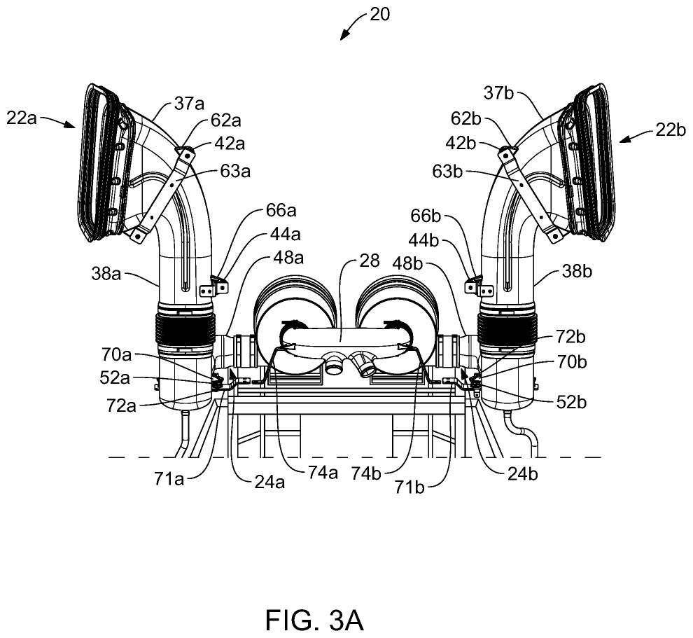

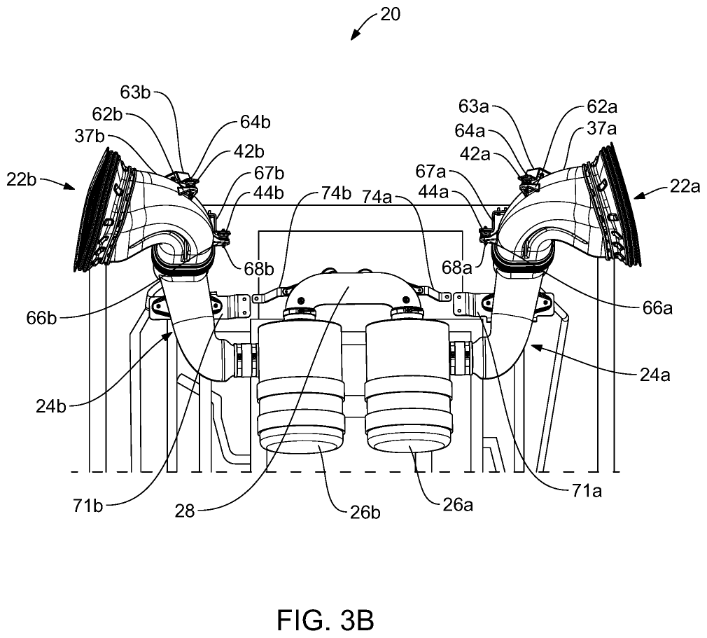

Further, coupling the air intake isolators 42a-42b and the additional air intake isolators 44a-44b to the intake portions 37a-37b and the downwardly extending portions 38a-38b of the respective air intakes 22a-22b is described in detail in conjunction with FIGS. 3A and 3B. Further, the air intake isolators 42a-42b and the additional pair of air intake isolators 44a-44b may be hereinafter collectively referred to as air intake isolators 42a-42b and 44a-44b. The present disclosure includes any number of air intake isolators numbering greater than or equal to one for each air intake 22a-22b in order to provide cushioning, thereby restricting and/or minimizing vibrations for safe and reliable performance of the respective air intakes 22a-22b.

With implementation of the air intake isolators 42a-42b and 44a-44b, the air intakes 22a-22b may be flexibly and securely coupled to the cab 16 of the vehicle 10 to provide relative movement. The design and coupling of the air intake isolators 42a-42b and 44a-44b may allow the clearance to be maintained, whereby movements of the cab 16 and the air intakes 22a-22b are provided and preserving alignment of the dual air intake system 20.

Further, coupling of the air intake isolators 42a-42b and 44a-44b to the components 37a-37b and 38a-38b of the respective air intake 22a-22b and to the cab 16 using the bracket and the fastener may dampen vibrations in the respective air intake 22a-22b resulting from e.g., vehicle movement over a terrain. In addition, such a coupling may absorb a relative motion, e.g., between the air intakes 22a-22b and the extender portion 30 of the cab 16 due to the operation/motion of the vehicle 10, to restrict excessive motion of the air intakes 22a-22b.

In some examples disclosed herein, each air intake 22a-22b forms a passageway including the divider 32a-32b (also be referred to as a central splitter, a water separator, or the like) for separating the water from the air. The divider 32a-32b may provide an enhanced surface area inside the respective air intake 22a-22b to effectively separate the water from the air. The separated air is further guided from each air intake 22a-22b to the respective outlet channel 24a-24b. The divider 32a-32b is described in detail in conjunction with FIG. 6.

In some examples, the air intakes 22a-22b may be coupled to the outlet channels 24a-24b via the flexible couplings 34a-34b. The flexible couplings 34a-34b are flexible structures made up of a certain number of convolutions. In embodiments, the flexible couplings 34a-34b can flex in any direction, at least to some extent. In at least one example, each convolution is operable to withstand pressure of the respective air intakes 22a-22b and the outlet channels 24a-24b.

Within the context of this disclosure, each of the flexible couplings 34a-34b has a proximal end (P) and a distal end (D). The proximal end (P) and the distal end (D) of the flexible coupling 34a-34b are parallel to each other. Further, the proximal end (P) and the distal end (D) of the flexible coupling 34a-34b have respective openings, wherein the openings of the distal end (D) are larger in diameter than the proximal end (P). The proximal end (P) of the flexible coupling 34a-34b may be coupled to a respective distal end of the respective air intake 22a-22b. The coupling may be accomplished in any manner (one or more fasteners, glue, sealant, brace, and the like) that maintains an airtight (or substantially airtight) pathway for air to travel therethrough. The respective distal end referred to herein may be an end opposite to the intake end 36a-36b of the respective air intake 22a-22b. Each flexible coupling 34a-34b may be coupled to the respective distal end of the respective air intake 22a-22b. The distal end (D) of the flexible coupling 34a-34b may be coupled to the respective outlet channel 24a-24b. Similarly, the flexible coupling 34a-34b may be accomplished in any manner as mentioned above, which maintains an airtight (or substantially airtight) pathway for air to travel therethrough.

The flexible couplings 34a-34b may undergo axial movements based on the motion of the vehicle 10 (and as mentioned are capable to flex in any other direction, i.e., can exhibit some degree of radial motion). The axial movements may be illustrated as movements of the flexible couplings 34a-34b in a direction of longitudinal axis. For example, the flexible couplings 34a-34b may contract/compress or may expand/extend. Such axial movements of the flexible couplings 34a-34b may absorb a relative motion between the cab 16 and the fuel cell stack 18 caused due to the motion of the vehicle 10. As a result, transfer of mechanical disturbances from the cab 16 and the fuel cell stack 18 to the air intakes 22a-22b and the outlet channels 24a-24b may be reduced, which may subsequently enhance the operations of the air intakes 22a-22b and the outlet channels 24a-24b and avoid degradation.

The outlet channels 24a-24b may be coupled to the respective air intakes 22a-22b and arranged on chassis 12 of the vehicle 10. The outlet channels 24a-24b may direct the moisture-reduced air separated from the water to the respective air filters 26a-26b and drain out the water separated from the air. Within the context of this disclosure, each outlet channel 24a-24b comprises a fluid collection portion 46a-46b, an exit portion 48a-48b that routes air to the respective air filters 26a-26b, and a drain port 50a-50b to direct separated water away from the air filters 26a-26b and fuel cell(s).

The fluid collection portion 46a-46b may be located beneath the divider 32a-32b of the respective air intake 22a-22b. The fluid collection portion 46a-46b may accumulate the water removed from the air. The accumulated water may be directed to the environment or another component through the drain port 50a-50b.

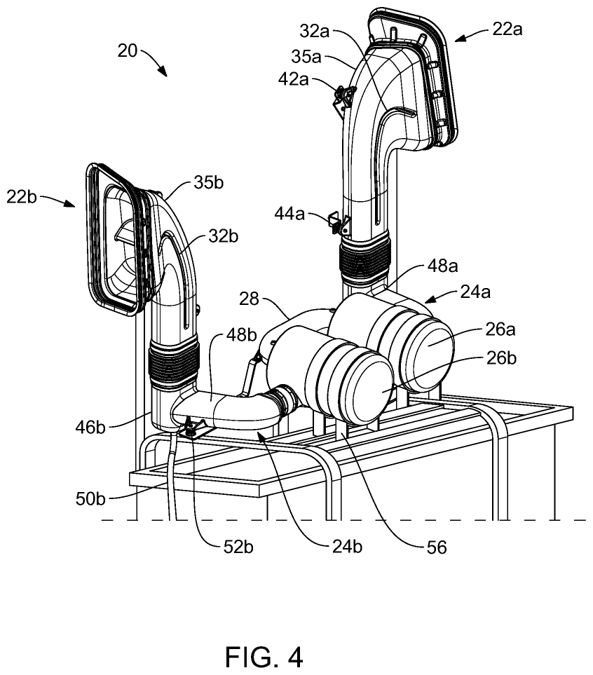

The exit portion 48a-48b may be located above the fluid collection portion 46a-46b. Further, the exit portion 48a-48b may guide the air (from which the water/moisture is removed) to one of the respective air filters 26a-26b. The fluid collection portion 46a-46b, the exit portion 48a-48b, and the drain port 50a-50b are described in detail in conjunction with FIG. 4.

In some examples, the dual air intake system 20 further comprises a pair of outlet channel isolators 52a-52b for use in coupling of the respective pair of outlet channels 24a-24b to the chassis 12 of the vehicle 10 (as illustrated in FIG. 1). Similar to the air intake isolators 42a-42b and 44a-44b, the outlet channel isolators 52a-52b may be frame-like structures arranged for coupling the outlet channels 24a-24b to the chassis 12 of the vehicle 10. For example, each outlet channel isolator 52a-52b may be coupled to the exit portion 48a-48b of the respective outlet channel 24a-24b and operable to be coupled to the chassis 12 of the vehicle 10 using suitable bracket and fastener. The fastener referred to herein may be a securing element, which secures the respective outlet channel isolator 52a-52b to the exit portion 48a-48b of the respective outlet channel 24a-24b and to the chassis 12. In some examples, the fastener may be a screw and bolt, a hook and barb, and/or the like. Further, coupling of the outlet channel isolator 52a-52b to the exit portion 48a-48b is described in detail in conjunction with FIGS. 3A and 3B.

With implementation of the outlet channel isolators 52a-52b, the respective outlet channels 24a-24b may be coupled firmly and securely to the chassis 12. In addition, the outlet channel isolators 52a-52b may absorb a relative motion caused between the respective outlet channels 24a-24b and the extender portion 30 of the cab 16 or may avoid degradation caused due to the relative motion of the vehicle 10 under a wide variety of operating conditions and driving terrain. The present disclosure includes any number of outlet channel isolators numbering greater than or equal to one for each outlet channel isolator 52a-52b in order to enable each outlet channel isolator 52a-52b to withstand a limited movement without degradation.

The air filters 26a-26b may be coupled to the respective outlet channels 24a-24b and to the manifold 28 (as illustrated in FIGS. 2A and 2B). For example, at one end, each air filter 26a-26b may be coupled to the respective one of the outlet channels 24a-24b and at the other end, each air filter 26a-26b has an air filter outlet 54a-54b coupled to the manifold 28. Further, the air filters 26a-26b may be arranged on the chassis 12 of the vehicle 10. In some examples, the air filters 26a-26b may be arranged on the chassis 12 of the vehicle 10 using respective filter isolators 56a-56b. The filter isolators 56a-56b are illustrated in FIG. 2B. In at least one example, each filter isolator 56a-56b comprises frames (e.g., circular in FIG. 2B) secured around a body of the respective air filter 26a-26b. Further, each frame has a hanging bar attached to it, wherein the hanging bar of the frame may be further attached to the chassis 12 of the vehicle 10. Thus, the filter isolators 56a-56b may be used to couple the respective air filters 26a-26b firmly and securely to the chassis 12 of the vehicle 10.

The air filters 26a-26b may receive the air (separated from the water/moisture) from the respective outlet channels 24a-24b, filter the air, and provide the filtered air to the manifold 28 through the respective air filter outlets 54a-54b. In at least one example, an air filter 26a-26b may filter the air by removing debris from the air. The air filter 26a-26b may include a synthetic fiber or a mesh with microscopic perforations for filtering the air. Examples of the air filter 26a-26b may include a pleated air filter, a non-pleated air filter, a paper air filter, a foam air filter, a plastic air filter, and/or the like. The debris removed from the air by the air filter 26a-26b may include one or more particles of nano size or pico size, or any particles below nano size.

The manifold 28 may be coupled to the one or more fuel cells of the fuel cell stack 18 through the outlets (i.e., manifold outlets). In at least one example, the manifold 28 having two outlets 58a-58b is illustrated in FIG. 2A, wherein the two outlets 58a-58b may be coupled to the two fuel cells of fuel cell stack 18 using a conduit (e.g., a hose, a seal, a brace, and/or the like). The manifold 28 of the present disclosure may have a number of outlets corresponding to a number of fuel cells included in the fuel cell stack 18.

The manifold 28 may receive the air (filtered air) from the air filters 26a-26b through the respective air filter outlets 54a-54b and supply the filtered air to the one or more fuel cells of the fuel cell stack 18. The manifold 28 may be designed to ensure that there is an equal amount of air supply/flow to each of the fuel cells of the fuel cell stack 18. For example, the equal amount of air supply to each of the fuel cells of the fuel cell stack 18 may be ensured due to the manifold 28, which is common for each of the air filters 26a-26b. Further, in the manifold 28, the air received from the air filters 26a-26b are mixed before being routed to each of the fuel cells of the fuel cell stack 18. Such mixing of the air may ensure equalized air being supplied to each of the fuel cells of the fuel cell stack 18.

FIGS. 3A and 3B are front and top perspective views, respectively, of the dual air intake system 20, according to an example of the present disclosure. With reference to FIGS. 3A and 3B, the air intake isolators 42a-42b and 44a-44b, an arrangement of the outlet channels 24a-24b, and the manifold 28 on frame rails (not shown) of the chassis 12 of the vehicle 10 are illustrated. In some examples, the air intake isolators 42a-42b and 44a-44b may include rubber bushes and/or the like.

Each air intake isolator 42a-42b may be coupled to the respective intake portion 37a-37b of the respective air intake 22a-22b and may be operable to be coupled to the cab 16 of the vehicle 10. In some examples, each air intake isolator 42a-42b may be coupled to an intake mount 62a-62b arranged on the intake portion 37a-37b of the respective air intake 22a-22b using a bracket 63a-63b and a fastener 64a-64b, as illustrated in FIG. 3B.

Similarly, each additional air intake isolator 44a-44b may be coupled to the downwardly extending portion 38a-38b of the respective air intake 22a-22b and may be operable to be coupled to the cab 16 of the vehicle 10. In some examples, each additional air intake isolator 44a-44b may be coupled to an additional intake mount 66a-66b arranged on the downwardly extending portion 38a-38b of the respective air intake 22a-22b using a bracket 67a-67b and a fastener 68a-68b, as illustrated in FIG. 3B.

Further, the outlet channel isolators 52a-52b may be used to couple the respective outlet channels 24a-24b to the frame rails of the chassis 12. Each outlet channel isolator 52a-52b may be coupled to the exit portion 48a-48b of the respective one of the outlet channels 24a-24b and operable to be coupled to the frame rails of the chassis 12. In some examples, the outlet channel isolator 52a-52b may be coupled to an outlet mount 70a-70b arranged on the exit portion 48a-48b of the respective outlet channel 24a-24b using a bracket 71a-71b and a fastener 72a-72b, as illustrated in FIG. 3A.

With implementation of the air intake isolators 42a-42b, and the outlet channel isolators 52a-52b, vibrations in the dual air intake system 20 may be reduced. Further, with implementation of the air intake isolators 42a-42b, and the outlet channel isolators 52a-52b, transferring of mechanical disturbances from the cab 16 and the one or more fuel cells of the fuel cell stack 18 to the air intakes 22a-22b and the outlet channel isolators 52a-52b may be reduced. As a result, the operations of each of the fuel cells may remain stable and in working condition, regardless of the motion of the vehicle 10.

The dual air intake system 20 further comprises manifold isolators 74a-74b for use in coupling of the manifold 28 to the frame rails of the chassis 12. The manifold isolators 74a-74b may be support/bracket-like structures coupled to the manifold 28 and to the frame rails of the chassis 12 using the fastener. In some examples, the fastener may be a screw and bolt, a hook and barb, and/or the like.

FIG. 4 is a rear left side perspective view of the dual air intake system 20, according to an example of the present disclosure. Examples herein describe operations of the dual air intake system 20 (i.e., supplying the air to the one or more fuel cells) by considering the air intake 22b, the outlet channel 24b, and the air filter 26b of the dual air intake system 20 for ease of description. The examples described herein may be equally applicable to the air intake 22a, the outlet channel 24a, and the air filter 26a.

The air intake 22b may allow the air to enter inside the dual air intake system 20 during the motion of the vehicle 10. By means of the divider 32b, the water that possibly enters along with the air may be separated. The water separated from the air may be accumulated in the fluid collection portion 46b formed by the outlet channel 24b (which may be arranged beneath the divider 32b) due to force of gravity. The water accumulated in the fluid collection portion 46b may be drained out using the drain port 50b. The drain port 50b may be arranged in a bottom wall of the fluid collection portion 46b. The fluid collection portion 46b may be positioned below the divider 32b, such that water can accumulate in the fluid collection portion 46b and be unable to travel upwards to the divider 32b due to gravity. For example, outlet channel 24b may be angle upwards from to fluid collection portion 46b to the air filter 26b. Such an arrangement reduces the water/moisture entering the air filter 26b/one or more fuel cells. Thus, the water accumulated in the fluid collection port 46 may be efficiently drained using the drain port 50b.

Further, the exit portion 48b of the outlet channel 24b may guide the air separated from the water to the respective air filter 26b. The exit portion 48b may be located above the fluid collection portion 46b, while forming an angle with respect to the fluid collection portion 46b. Further, the exit portion 48b has a bendable portion that may extend towards the respective air filter 26b and due to which the angle formed by the exit portion 48b may be slanted up towards the respective air filter 26b. Such an arrangement of the exit portion 48b (and outlet channel 24b generally) may enable any water/moisture which manages to pass by the fluid collection portion 46b, to be routed back to the fluid collection portion 46b by force of gravity. In other words, the arrangement is such that water/moisture would have to travel uphill to reach the divider 32b. In such a way, loading of the air filter 26b with the water/moisture may be reduced. As a result, efficiency and service life of the air filter 26b may be enhanced.

The air filter 26b may filter the air received from the outlet channel 24b and supply the filtered air to the manifold 28, which may further distribute the air in substantially equal proportion to each fuel cell of the fuel cell stack 18.

FIG. 5 is a side perspective view of the air intake 22b of the dual air intake system 20, according to an example of the present disclosure. Although the air intake 22b is illustrated in FIG. 5, the examples described herein with respect to the air intake 22b may be equally applicable to the other air intake 22a.

The air intake 22b may allow the air for operation of the one or more fuel cells of the fuel cell stack 18 to be received from the surroundings of the vehicle 10. In some examples, the air intake 22b may be constituted by two separate molding parts (also be referred to as injection molding parts, molding shelves, and/or the like). The molding parts may be comprised of a plastic material, which may ensure rigidity of the air intake 22b. Further, among the two molding parts, one molding part may be heavy and the other may be light. Within the context of this disclosure, the two molding parts may be manufactured separately and then assembled by arranging/positioning the divider 32b in between the two molding parts, thereby forming the air intake 22b. In some examples, the two molding parts may be assembled using glue. In some examples, the two molding parts may be assembled using a blow molding method, an injection molding method, and/or the like.

The air intake 22b comprises the intake end 36b, which faces outward relative to a normal travel direction of the vehicle 10. In some examples, the intake end 36b has the flexible gasket 40b affixed thereto. As an example, the flexible gasket 40b may be comprised of a three dimensional (3D) printed rubber material having a flexible structure (e.g., bellows-like structure). In some examples, the flexible gasket 40b may be coupled to the respective intake end 36b of the respective air intake 22b by a plurality of protrusions on an exterior of the intake end 36b and receiving portions on the flexible gasket 40b. In some examples, the protrusions may comprise glue, sealing rubber, pressure fit, screws, nuts, and/or the like.

In some examples, being positioned on the intake end 36b, the flexible gasket 40b may be operable to couple with the cab 16 of the vehicle 10. For example, the flexible gasket 40b may be operable to couple to the extender portion 30 of the cab 16, while applying pressure through the respective flexible coupling 34b and to stretch more into the respective intake end 36b and the respective extender portion 30 of the cab 16. Such an arrangement of the flexible gasket 40b may absorb a relative motion between the extender portion 30 of the cab 16 and the air intake 22b and reduce or prevent vibrations being translated throughout the dual air intake system 20. As a result, degradation of one or more components of the air intake system 20 as a result of vehicle operation may be reduced or avoided, and hence uncompromised air supply to the fuel cell stack 18 may be ensured.

In some examples, the intake end 36b has a mesh 76b for preventing debris or large volume of foreign particles entering the intake end 36b. The mesh 76b may be coupled to an outer periphery of the intake end 36b. In some examples, the mesh 76b may be coupled to the outer periphery of the intake end 36b using a sealing rubber (or any other suitable sealing mechanism), which protrudes outward on the outer periphery of the intake end 36b. Thus, the mesh 76b may be coupled and decoupled from the intake end 36b easily (e.g., for cleaning purposes).

The downwardly extending portion 38b may extend from the respective intake end 36b. Further, the downwardly extending portion 38b may form an angle relative to the intake end 36b. In embodiments, the angle is substantially perpendicular to the intake end 36b (e.g., within 5, 10, 20, 30 degrees of perpendicular, or any value therebetween). With such an arrangement, and inclusive of the divider 32b, water may be effectively separated from the air drawn into the intake end 36b to settle in the fluid collection portion 46b of the outlet channel 24b.

FIG. 6 is a cross-sectional view of the air intake 22b of the dual air intake system 20, according to an example of the present disclosure. Although the air intake 22b is described with reference to FIG. 6, the examples described herein are equally applicable to the air intake 22a and its corresponding components.

As illustrated in FIG. 6, the divider 32b of the air intake 22b may be arranged upstream of an inflow side of the air filter 26b and may be elongated/extended from proximal to the intake end 36b of the air intake 22b till near a bottom of the air intake 22b. For example, the divider 32b may extend from proximal to the intake end 36b through a portion of the downwardly extending portion 38b of the air intake 22b, thereby forming a cane-like structure. Further, the divider 32b forms an angle relative to the intake end 36b of the air intake 22b. In some examples, the angle may be slanted up with respect to the air filter 26b to preserve moisture away from the air filter 26b. In some examples, the angle formed by the divider 32b relative to the intake end 36b may be between 30 degrees and 60 degrees.

The divider 32b may separate the water from the air, wherein the separated water may go beneath the divider 32b. Further, due to an elongated length of the divider 32b and the angle formed by the divider 32b relative to the air intake 22b, a large volume of water particles/density of moisture may be allowed to go below the divider 32b and accumulate at the fluid collection portion 46b of the outlet channel 24b.

In some examples, the divider 32b may comprise a plurality of water separating surfaces (not shown) for separating the water from the air. Each water separating surface may be elongated horizontally and may have a first end positioned at the intake end 36b and a second end positioned opposite to the respective outlet channel 24b.

Thus, with the proposed arrangement of the divider 32b, a surface area to separate the water/moisture from the air may be enhanced/maximized and the cleaner air may be directed to the air filter 26b while channeling the separated water to drain.

FIG. 7 is a block diagram of a system 80 for the vehicle 10, according to an example of the present disclosure. As depicted in FIG. 7, the system 80 includes the air intakes 22a-22b, the fuel cell stack 18, the manifold 28, air intake sensors 82a-82b, air flow enhancement devices/actuators 84a-84b, and a controller 86. Suitable examples of the controller 86 include, but are not limited to, an electronic control unit (ECU), microcomputer, or powertrain control module (PCM) with processing and memory capabilities, programmed to receive sensor inputs and control the operation of air flow enhancement devices and other system components according to stored instructions.

The air intakes 22a-22b may be connected to the manifold 28. The manifold 28 may be further connected to the fuel cell stack 18, which may include e.g., two or more fuel cells. The manifold 28 may be configured to receive the air from the air intakes 22a-22b through the air filters 26a-26b coupled to the outlet channels 24a-24b of the respective air intakes 22a-22b. The air received by the manifold 28 may be the air filtered by the air filters 26a-26b. The manifold 28 may also be configured to supply the received air to each of the fuel cells of the fuel cell stack 18 in substantially equal portion.

The air intakes 22a-22b may be further connected to the air intake sensors 82a-82b and the air flow enhancement devices 84a-84b. In some examples, the air intake sensors 82a-82b may include two or more air sensors. Each air sensor may include Mass Air Flow Sensor (MAF). The air intake sensors 82a-82b may be configured to measure air flow to the respective air intakes 22a-22b. In some examples, each of the air flow enhancement devices 84a-84b may include two or more air flow enhancement devices, which are fluidly connected to the respective air intake 22a-22b. An example of the air flow enhancement device 84 may include a turbocharger, which is electrically operable. The air flow enhancement devices 84a-84b may be operated to draw the air into the respective air intakes 22a-22b, based on the air flow to the respective air intakes 22a-22b.

The controller 86 may be configured to control the air intake sensors 82a-82b and the air flow enhancement devices 84a-84b. In some examples, the controller 86 may be an electronic controller having an electrical circuitry configured to process signals from the air intake sensors 82a-82b and accordingly to generate instruction signals for controlling the air flow enhancement devices 84a-84b. The signals obtained from the air intake sensors 82a-82b may be indicative of the measured air flow to the air intakes 22a-22b. For example, the air intake sensors 82a-82b may be configured to output the signals indicative of a rate of air flow to the air intakes 22a-22b.

In some implementations of the present disclosure, the controller 86 may be configured as a microcomputer (not shown) or a powertrain control module (PCM). The microcomputer may include a processor, and a memory coupled to the processor. The microcomputer may also include input/output ports, one or more storage devices, and/or other suitable components. The processor may include multiple microprocessors, general purpose microprocessors, special-purpose microprocessors, application specific integrated circuits (ASICS), or any combination thereof. The memory, e.g., non-transitory memory may include read only memory, random access memory, and/or the like. The memory may store instructions or codes, which can be executed by the processor causing the controller 86 to control the air flow enhancement devices 84a-84b.

The controller 86 may control the air flow enhancement devices 84a-84b based on various inputs or factors, including the signals (indicative of the rate of air flow to the air intakes 22a-22b) obtained from the air intake sensors 82a-82b. Based on the rate of air flow to the air intakes 22a-22b, the controller 86 may actuate the air flow enhancement devices 84a-84b to operate for drawing the air into the respective air intakes 22a-22b. For example, the controller 86 may actuate the air flow enhancement devices 84a-84b to draw the air into the respective air intakes 22a-22b when the signals obtained from the air intake sensors 82a-82b provide an indication that the air flow to the air intakes 22a-22b is below a predetermined air intake threshold. Therefore, the air flow enhancement devices 84a-84b may be actuated in situations when the air flow to the respective air intakes 22a-22b is low.

In some examples, the controller 86 may actuate each of the air flow enhancement devices 84a-84b at same time or at different times, by comparing the rate of air flow to one air intake 22a-22b with the other air intake 22a-22b.

In some examples, the controller 86 may control operational status of each of the air flow enhancement devices 84a-84b as a function of the measured air flow by the air intake sensors 82a-82b. In some examples, the controller 86 may control the operational status of the air flow enhancement devices 84a-84b based on operating conditions of the vehicle 10 and/or environmental conditions surrounding the vehicle 10.

Examples herein provide the dual air intake system 20 for supplying filtered air separated from water/moisture to the one or more fuel cells of the vehicle 10, while reducing or avoiding the risk of air intake deficiencies and ram air effects due to overall design as disclosed herein. The dual air intake system 20 comprises the pair of air intakes 22a-22b, which are arranged at a back of the cab 16 of the vehicle 10 and facing outward (i.e., substantially perpendicular) relative to a normal (i.e., forward) travel direction of the vehicle 10. Such an arrangement of the pair of air intakes 22a-22b may provide continuous, balanced/even, and redundant distribution of air to each of the one or more fuel cells of the vehicle 10.

Further, the dual air intake system 20 comprises components such as the flexible couplings 34a-34b, the air intake isolators 42a-42b, the additional air intake isolators 44a-44b, the outlet channel isolators 52a-52b, the fasteners, or the like, to compensate for relative movements between the cab, an extender portion 30 of the cab, and the one or more fuel cells.

For example, the components of the dual air intake system 20 may be pre-manufactured separate from each other as modular components. The modular components may be then coupled as needed, in particular as a function of the intended use and/or a location of use of the vehicle 10. Alternatively, at least two components of the dual air intake system 20 may be monolithically coupled to each other. In such a way, the monolithic components may be produced together.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

Furthermore, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically interacting components and/or wirelessly interactable and/or wirelessly interacting components and/or logically interacting and/or logically interactable components. Furthermore, it will be understood that a component preceding the term “of the” may be disposed at any practicable location (e.g., on, within, and/or externally disposed from the vehicle) such that the component may function in any manner described herein.

Aspects of the present disclosure may be implemented according to one or more of the following clauses.

Clause 1. A dual air intake system, comprising: a pair of air intakes, each of the pair of air intakes forming a passageway that includes a divider; a pair of outlet channels, each of the pair of outlet channels coupled to a respective one of the pair of air intakes; a pair of air filters, each of the pair of air filters coupled to a respective one of the pair of outlet channels; and a manifold coupled to an outlet of each of the pair of air filters, wherein the manifold has at least two outlets each configured to be coupled to at least one respective fuel cell.

Clause 2. The dual air intake system as recited in clause 1, wherein each of the pair of air intakes includes an intake end having a flexible gasket affixed thereto.

Clause 3. The dual air intake system as recited in any preceding clause, wherein the flexible gasket is operable to contact a cab of a heavy vehicle or an extender portion of the cab.

Clause 4. The dual air intake system as recited in any preceding clause, wherein the flexible gasket is coupled to a respective one of the pair of air intakes by a plurality of protrusions on an exterior of the respective one of the pair of air intakes and receiving portions on the flexible gasket.

Clause 5. The dual air intake system as recited in any preceding clause, wherein an intake end of a first one of the pair of intakes faces away from an intake end of a second one of the pair of intakes.

Clause 6. The dual air intake system as recited in any preceding clause, wherein the intake end of the first one of the pair of intakes is spaced a distance away from the intake end of the second one of the pair of intakes, and wherein the distance is substantially a width of a vehicle.

Clause 7. The dual air intake system as recited in any preceding clause, wherein the divider forms an angle relative to an intake end of a respective one of the pair of air intakes.

Clause 8. The dual air intake system as recited in any preceding clause, wherein the angle is between about 30 degrees and 60 degrees.

Clause 9. The dual air intake system as recited in any preceding clause, wherein each of the pair of intakes includes a downwardly extending portion that extends from an intake end.

Clause 10. The dual air intake system as recited in any preceding clause, wherein the downwardly extending portion forms an angle relative to the intake end.

Clause 11. The dual air intake system as recited in any preceding clause, wherein the divider extends from a position proximal to the intake end through at least a portion of the downwardly extending portion.

Clause 12. The dual air intake system as recited in any preceding clause, further comprising a pair of flexible couplings, each of the pair of flexible couplings attached to a respective distal end of one of the pair of air intakes, wherein the respective distal end is opposite to an intake end.

Clause 13. The dual air intake system as recited in any preceding clause, wherein a proximal end of one of the pair of flexible couplings is attached to the respective distal end of the one of the pair of air intakes and a distal end of the one of the pair of flexible couplings is attached to a respective one of the pair of outlet channels.

Clause 14. The dual air intake system as recited in any preceding clause, wherein the pair of outlet channels includes a fluid collection portion.

Clause 15. The dual air intake system as recited in any preceding clause, wherein each of the pair of outlet channels includes an exit portion located above the fluid collection portion, where each of the pair of outlet channels extends in an upward direction at an angle with respect to the fluid collection portion.

Clause 16. The dual air intake system as recited in any preceding clause, further comprising a pair of outlet channel isolators, wherein a respective one of the pair of outlet channel isolators is coupled to the exit portion of the respective one of the pair of outlet channels and is operable to be coupled to a chassis of a vehicle.

Clause 17. The dual air intake system as recited in any preceding clause, further comprising a pair of air intake isolators, wherein a respective one of the air intake isolators is coupled to an intake portion of a respective one of the pair of air intakes and is operable to be coupled to a cab of a heavy vehicle.

Clause 18. The dual air intake system as recited in any preceding clause, further comprising an additional pair of air intake isolators, wherein a respective one of the additional pair of air intake isolators is coupled to a downwardly extending portion of a respective one the pair of air intakes and is operable to be coupled to a cab of a heavy vehicle.

Clause 19. A vehicle, comprising: a pair of air intakes, each of the pair of air intakes forming a passageway that includes a divider; a pair of outlet channels, each of the pair of outlet channels coupled to a respective one of the pair of air intakes; a pair of air filters, each of the pair of air filters coupled to a respective one of the pair of outlet channels; and a manifold coupled to an outlet of each of the pair of air filters, wherein the manifold has at least two outlets each configured to be coupled to at least one respective fuel cell.

Clause 20. A system for a vehicle, comprising: two or more fuel cells; two or more air intakes; and a single manifold configured to receive air from each of the two or more air intakes and supply the air in substantially equal portion to each of the two or more fuel cells.

Clause 21. The system of clause 20, further comprising: two or more air flow enhancement devices, each of the two or more air flow enhancement devices fluidly coupled to one of each of the two or more air intakes; and a controller storing instructions in non-transitory memory that, when executed, cause the controller to actuate at least one of the two or more air flow enhancement devices to operate to draw air into at least one of the two or more air intakes.

Clause 22. The system of any preceding clause, further comprising: two or more air intake sensors, each configured to measure air flow entering into a respective one of the two or more air intakes; and wherein the controller stores further instructions to control an operational status of one or more of the two or more air flow enhancement devices as a function of measured air flow via one or more of the two or more air intake sensors.

Clause 23. The system of any preceding clause, wherein one or more of the two or more air flow enhancement devices is electrically operable, or wherein one or more of the two or more air flow enhancement devices is a turbocharger. air flow enhancement device

Clause 24. The system of any preceding clause, wherein the controller stores further instructions to: actuate at least one of the two or more air flow enhancement devices in response to an indication that air flow into one or more of the two or more air intakes is below a predetermined air intake threshold.

Unless the context indicates otherwise, throughout the above specification and claims which follow, the word “comprise” and variations thereof, such as, “comprises” and “comprising” are to be construed in an open, inclusive sense that is as “including, but not limited to.” Further, the terms “first,” “second,” and similar indicators of the sequence are to be construed as interchangeable unless the context clearly dictates otherwise.

Reference throughout this specification to “one aspect” or “an aspect” means that a particular feature, structure, or characteristic described in connection with an example is included in at least one aspect. Thus, the appearances of the phrases “in one aspect” or “in an aspect” in various places throughout this specification are not necessarily all referring to the same example. Furthermore, the particular features, structures, or characteristics may be combined in any suitable manner in one or more aspects.

As used in this specification and the appended claims, the singular forms “a,” “an,” and “the” include plural referents unless the content clearly dictates otherwise. It should also be noted that the term “or” is generally employed in its broadest sense, that is, as meaning “and/or” unless the content clearly dictates otherwise.

Note that, various actions, operations, and/or functions performed by the system disclosed herein may be stored as executable instructions in non-transitory memory and may be carried out by the controller in combination with various sensors, actuators, and other engine hardware of the vehicle. As such, various actions, operations, and/or functions illustrated may be performed in the sequence illustrated, in parallel, or in some cases omitted. Likewise, the order of processing is not necessarily required to achieve the features and advantages of the example embodiments described herein but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the system, where the described actions are carried out by executing the instructions in the system including the various engine hardware components in combination with the controller.

The foregoing discussion of the disclosure has been presented for purposes of illustration and description. The foregoing is not intended to limit the disclosure to the form or forms disclosed herein. In the foregoing detailed description for example, various features of the disclosure are grouped together in one or more examples, configurations, or aspects for the purpose of streamlining the disclosure. The features of the examples, configurations, or aspects of the disclosure may be combined in alternate examples, configurations, or aspects other than those described above. Hence, the present disclosure and drawings should not be considered in a limiting sense, as it is understood that an aspect presented within a disclosure is in no way limited to those examples specifically illustrated.

Accordingly, the above description and any accompanying drawings, illustrations, and figures are intended to be illustrative but not restrictive. The scope of any aspect presented within this disclosure should, therefore, be determined not with simple reference to the above description and those examples shown in the figures, but instead should be determined with reference to the pending claims along with their full scope or equivalents.

Also, though the description of the disclosure has included description of one or more examples, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative examples, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A dual air intake system, comprising:
a pair of air intakes, each of the pair of air intakes forming a passageway that includes a divider;
a pair of outlet channels, each of the pair of outlet channels coupled to a respective one of the pair of air intakes;
a pair of air filters, each of the pair of air filters coupled to a respective one of the pair of outlet channels; and
a manifold coupled to an outlet of each of the pair of air filters, wherein the manifold has at least two outlets each configured to be coupled to at least one respective fuel cell.

2. The dual air intake system as recited in claim 1, wherein each of the pair of air intakes includes an intake end having a flexible gasket affixed thereto.

3. The dual air intake system as recited in claim 2, wherein the flexible gasket is operable to contact a cab of a heavy vehicle or an extender portion of the cab.

4. The dual air intake system as recited in claim 2, wherein the flexible gasket is coupled to a respective one of the pair of air intakes by a plurality of protrusions on an exterior of the respective one of the pair of air intakes and receiving portions on the flexible gasket.

5. The dual air intake system as recited in claim 2, wherein an intake end of a first one of the pair of intakes faces away from an intake end of a second one of the pair of intakes.

6. The dual air intake system as recited in claim 5, wherein the intake end of the first one of the pair of intakes is spaced a distance away from the intake end of the second one of the pair of intakes, and wherein the distance is substantially a width of a vehicle.

7. The dual air intake system as recited in claim 1, wherein the divider forms an angle relative to an intake end of a respective one of the pair of air intakes.

8. The dual air intake system as recited in claim 7, wherein the angle is between about 30 degrees and 60 degrees.

9. The dual air intake system as recited in claim 1, wherein each of the pair of intakes includes a downwardly extending portion that extends from an intake end.

10. The dual air intake system as recited in claim 9, wherein the downwardly extending portion forms an angle relative to the intake end.

11. The dual air intake system as recited in claim 9, wherein the divider extends from a position proximal to the intake end through at least a portion of the downwardly extending portion.

12. The dual air intake system as recited in claim 1, further comprising a pair of flexible couplings, each of the pair of flexible couplings attached to a respective distal end of one of the pair of air intakes, wherein the respective distal end is opposite to an intake end.

13. The dual air intake system as recited in claim 12, wherein a proximal end of one of the pair of flexible couplings is attached to the respective distal end of the one of the pair of air intakes and a distal end of the one of the pair of flexible couplings is attached to a respective one of the pair of outlet channels.

14. The dual air intake system as recited in claim 1, wherein the pair of outlet channels includes a fluid collection portion.

15. The dual air intake system as recited in claim 14, wherein each of the pair of outlet channels includes an exit portion located above the fluid collection portion, where each of the pair of outlet channels extends in an upward direction at an angle with respect to the fluid collection portion.

16. The dual air intake system as recited in claim 15, further comprising a pair of outlet channel isolators, wherein a respective one of the pair of outlet channel isolators is coupled to the exit portion of the respective one of the pair of outlet channels and is operable to be coupled to a chassis of a vehicle.

17. The dual air intake system as recited in claim 16, further comprising a pair of air intake isolators, wherein a respective one of the air intake isolators is coupled to an intake portion of a respective one of the pair of air intakes and is operable to be coupled to a cab of a heavy vehicle.

18. The dual air intake system as recited in claim 17, further comprising an additional pair of air intake isolators, wherein a respective one of the additional pair of air intake isolators is coupled to a downwardly extending portion of a respective one the pair of air intakes and is operable to be coupled to a cab of a heavy vehicle.

19. A vehicle, comprising:
a pair of air intakes, each of the pair of air intakes forming a passageway that includes a divider;
a pair of outlet channels, each of the pair of outlet channels coupled to a respective one of the pair of air intakes;
a pair of air filters, each of the pair of air filters coupled to a respective one of the pair of outlet channels; and
a manifold coupled to an outlet of each of the pair of air filters, wherein the manifold has at least two outlets each configured to be coupled to at least one respective fuel cell.

20. A system for a vehicle, comprising:
two or more fuel cells;
two or more air intakes; and
a single manifold configured to receive air from each of the two or more air intakes and supply the air in substantially equal portion to each of the two or more fuel cells.

21. The system of claim 20, further comprising:
two or more air flow enhancement devices, each of the two or more air flow enhancement devices fluidly coupled to one of each of the two or more air intakes; and
a controller storing instructions in non-transitory memory that, when executed, cause the controller to actuate at least one of the two or more air flow enhancement devices to operate to draw air into at least one of the two or more air intakes.

22. The system of claim 21, further comprising:
two or more air intake sensors, each configured to measure air flow entering into a respective one of the two or more air intakes; and
wherein the controller stores further instructions to control an operational status of one or more of the two or more air flow enhancement devices as a function of measured air flow via one or more of the two or more air intake sensors.

23. The system of claim 21, wherein one or more of the two or more air flow enhancement devices is electrically operable, or wherein one or more of the two or more air flow enhancement devices is a turbocharger.

24. The system of claim 21, wherein the controller stores further instructions to:
actuate at least one of the two or more air flow enhancement devices in response to an indication that air flow into one or more of the two or more air intakes is below a predetermined air intake threshold.
